(19) United States
(12) Patent Application Publication
(10) Pub. No.: US 2018/0077866 A1
(43) Pub. Date: Mar. 22, 2018

(54) HARVESTING DEVICE

(71) Applicant: Mosman Machinery Company, Inc., Nevada City, CA (US)

(72) Inventors: Angel Ramon Torrado Perez, Lakewood, CO (US); Dana Eliot Mosman, Boulder, CO (US); Donald Mosman, Nevada City, CA (US)

(21) Appl. No.: 15/711,069

(22) Filed: Sep. 21, 2017

Related U.S. Application Data
(60) Provisional application No. 62/398,368, filed on Sep. 22, 2016.

(51) Int. Cl. A01D 43/08; A01D 25/04

(52) U.S. Cl. CPC A01D 43/086; A23N 15/01; A01D 25/04

(57) ABSTRACT

The present invention shows an apparatus for trimming plants, specifically assisting with the process of separating leaves and buds from the stem and branches of the plant. The apparatus is composed by an iris mechanism with blades that adapt to the diameter of the stem, and a feeding mechanism that forces the plant trough the iris. The buds and leaves are by these means separated from the stem due to the shear forces imposed by the blades. All of the waste is collected in the back of the apparatus and separated from the buds and leaves that are ready to be further processed to achieve the state needed for their final application.

### RELATED APPLICATIONS

This application claims priority benefit of U.S. Provisional Patent Application No. 62/398,368, entitled “HARVESTING DEVICE”, filed Sep. 22, 2017, which application is incorporated herein by reference in its entirety.

### FIELD OF THE INVENTION

The present disclosure is directed to the trimming of plants, and in particular to the removing of material such a leaves, buds and flowers from a stem portion of a plant.

### BACKGROUND

Flowers, buds and leaves harvested from stemmed plants are often used in oils, medicinal products, aromatherapy, cuisine, perfumes, dyes, oils, toilet preparations, tinctures, distillation products (steam distillation of lavender oil), and the like. Such stemmed plants are sometimes cut at the base of the stem (e.g., trunk, stalk, etc.) in the field and transported to a location for processing.

Commonly, such processing requires numerous workers who manually strip useful portions of the plant (leaves, buds, etc.) from the generally less useful stem portion(s). This processing may be labor intensive, repetitive and time-consuming. In addition, it is not appealing to many workers. Accordingly, there is a need in the art for a method and mechanical apparatus for separating buds and leaves from the stem and/or branches of stemmed plants that reduces labor requirements.

### SUMMARY

Aspects of the presented inventions are directed to a harvesting device that strips material of a plant from a stern portion of a plant. One aspect is directed to an adjustable iris mechanism that includes a plurality of blades. More specifically, the positions of the blades are adjustable to define an opening or orifice into which a stem of a plant may be inserted (e.g., a cut base of the stalk). Once inserted within the orifice, the blades of the iris may tighten around the stern. Drawing the remainder of the stern through the iris mechanism draws leaves, buds, etc. (e.g., plant material) of the plant across cutting surfaces of the blades. This action removes plant material from the stem to permit subsequent use and/or processing. In one arrangement, the blades may be arranged so that they are equally spaced about the opening of the iris. Further, the position of the blades may be easily and simultaneously adjusted to modify the size of the orifice. In one arrangement, the blades may be spring loaded such that they automatically adjust to the size of the stem positioned within the orifice. This allows, for example, reducing the size of the orifice as the size of the stem decreases as it is pulled through the harvesting device. In another arrangement, the position of the blades may be manually adjusted and in yet another arrangement, the position of the blades may be automatically adjusted using a sensor.

In an embodiment of the presented inventions, a harvesting device for separating plant material from a stem and branches of a plant is described. The harvesting device may comprise an iris mechanism and a drive mechanism. The iris mechanism may comprise an outer ring, an inner ring concentrically disposed within the outer ring, and a plurality of blades. Each blade of the plurality of blades may be pivotally attached to the outer ring and pivotally attached to the inner ring. The plurality of blades may be configured to form a cutting orifice such that rotation of the outer ring changes a dimension of the cutting orifice. The drive mechanism may comprise a first electric motor, a first drive roller rotationally powered by the first electric motor, and a second drive roller. The first and second drive rollers may be configured to receive and engage a stem of a plant to pull the plant through the cutting orifice.

In an aspect, a harvesting device may also include a second drive motor. The second drive roller may be rotationally powered by the second drive motor, and a direction of rotation of the first drive motor may be opposite of a direction of rotation of the second drive motor.

In another aspect, a harvesting device may include and upper bracket and a lower bracket. The first drive roller may be mounted to the upper bracket and the second drive roller may be mounted the lower bracket. The lower bracket may be pivotally affixed to the upper bracket such that insertion of a stem of a plant may cause the lower bracket to pivot in a first direction with respect to the upper bracket, thereby increasing a dimension of a gap between the first and second drive rollers. The harvesting device may also include a biasing member configured to pivot the lower bracket in a second direction, opposite the first direction, with respect to the upper bracket.

In another aspect, a harvesting device may include an actuating means for rotating the outer ring. An actuating means may comprise at least one actuator and at least one biasing member. A first actuator may be configured to rotate the outer ring with respect to the inner ring when the first actuator is actuated (e.g., when a shaft of the actuator has been extended). A first biasing member may be configured to return the outer ring to a resting position when the first actuator is inactive (e.g., when a shaft of the actuator has been withdrawn).

In yet another aspect, a shaft of an actuator of a harvesting device may be configured to engage a portion of one of a plurality of blades such that a force exerted on the one of the plurality of blades by the shaft of the first actuator may cause the outer ring to rotate.

In an aspect, each of a plurality of blades may comprise a slot through which an attachment element is disposed to pivotally attach each of the plurality of blades to an outer ring. In this regard, each of the plurality of blades may be configured to slide in relation to a respective attachment element in conjunction with rotation of the outer ring.

In another aspect, a harvesting device may comprise a sensor configured to determine a magnitude of a gap between the first and second drive rollers and in a further aspect, a harvesting device may include a control panel comprising a processing engine. A control panel may be in operative communication with the sensor, the first electric motor, and the first actuator. In this regard, a control panel may be configured to receive an output signal from the sensor corresponding to a magnitude of the gap between the first and second drive rollers and transmit an iris control signal to an actuator in response to the output signal.

In yet another aspect, an output signal transmitted from a sensor may indicate an increase in magnitude of a gap between first and second driver rollers. A control panel may be operable to transmit a motor control signal to the first drive motor in response to receipt of the output signal. Such a motor control signal may be configured to increase an operational speed of the first drive motor. A harvesting device may also comprise a second actuator configured to rotate the outer ring with respect to the inner ring when the second actuator is actuated. In this regards, a first actuator and a second actuator may act in conjunction with one another.

In another aspect, a harvesting device may comprise a housing. A housing may include a front plate and a plurality of walls extending normally from (e.g., transverse to) the front plate. In this regard, a housing may forms an enclosure around at least a portion of the iris mechanism and the drive mechanism.

In yet another aspect, a housing of a harvesting device may include a back plate disposed at an end of the plurality of walls opposite the front plate. A housing, including a front plate, a plurality of walls, and a back plate may be constructed from a metal. For example, steel, aluminum, iron, or a combination thereof.

In another aspect, a harvesting device may further comprise a stand. A stand may include, for example, a body, a plurality of wheels (e.g., two), and a handle. A housing of a harvesting device may be mounted to the body of the stand. In this regard, a portion of the housing may be configured to receive corresponding mounting members of the stand. For example, opposing sidewalls of the housing may each comprise a recess sized to accept a protrusion (e.g., bracket, peg, etc.) extending from the body of the stand. In this regard, the harvesting device may be disposed independently of the stand for on a table top or on the ground, or may be mounted to the stand such that the harvesting device is elevated and the plurality of wheels may facilitate relocation. Furthermore, mounting members of the stand may facilitate rotation of the harvesting device within the stand. For example, the harvesting device may be locked into a desirable orientation such that the iris mechanism is disposed at an angle which facilitates ease of use. The angle of orientation may be adjusted as desired and a locking element, such as a handle or knob, may be provided to retain the angle of orientation.

In another embodiment of the presented inventions, a method for removing plant material from a plant is described. The method may include receiving a portion of a plant in drive mechanism of a harvesting device and rotating a first drive roller and a second drive roller of the drive mechanism to engage the portion of the plant and pull the plant through the harvesting device. The method may further include manipulating an actuating means to rotate an outer ring of an iris mechanism in a first direction about a concentrically disposed inner ring, such that rotation of the outer ring causes repositioning of a plurality of blades affixed to the outer ring and inner ring which form a cutting orifice. The method may further include stripping, with the cutting orifice, plant material from a stem of the plant as the drive mechanism pulls the plant through the harvesting device.

In an aspect of the method, the actuating means may comprise a linear actuator and the method may further comprise detecting, using a sensor, a magnitude of a gap between the first roller and the second roller and manipulating, in response to the detecting, a shaft of the linear actuator to reposition the plurality of blades to size the cutting orifice based upon the detected magnitude of the gap.

In another aspect, engagement of a portion of the plant may cause a lower bracket to which the second drive roller is attached to pivot in relation to an upper bracket to which the first drive roller is attached.

In a further aspect, the method may include operating the first and second drive rollers at a first rotational speed and operating the first and second drive rollers at a second rotational speed based upon detecting an increase in the magnitude of the gap. The second rotational speed may be faster than the first rotational speed.

In a still further aspect, the method may include detecting a decrease in the magnitude of the gap and operating, in response to the detecting the decrease in the magnitude of the gap, the first and second drive rollers at the first rotational speed.

In yet another aspect, the method may include manipulating, in response to the detecting the decrease in the magnitude of the gap, the shaft of the linear actuator to allow a biasing spring to rotate the outer ring a second direction, wherein the second direction is opposite of the first direction.

### BRIEF DESCRIPTION OF THE DRAWINGS

FIGS. 1A and 1B illustrate perspective views of an embodiment of a harvesting device in accordance with the presented inventions.

FIGS. 2A-2C illustrate rear perspective views of the embodiment of a harvesting device.

FIG. 3 illustrates a left-side view of the embodiment of a harvesting device.

FIG. 4 illustrates a right-side view the embodiment of a harvesting device.

FIGS. 5A and 5B illustrate rear views of the embodiment of a harvesting device.

FIG. 6A illustrates a front perspective view of an iris mechanism of the embodiment.

FIG. 6B illustrates a cross-sectional rear perspective view of the iris mechanism.

FIG. 7 is a flow chart of a method of operating a harvesting device.

### DETAILED DESCRIPTION

Reference will now be made to the accompanying drawings, which at least assist in illustrating the various pertinent features of the presented inventions. The following description is presented for purposes of illustration and description and is not intended to limit the inventions to the forms disclosed herein. Consequently, variations and modifications commensurate with the following teachings, and skill and knowledge of the relevant art, are within the scope of the presented inventions. The embodiments described herein are further intended to explain the best modes known of practicing the inventions and to enable others skilled in the art to utilize the inventions in such, or other embodiments and with various modifications required by the particular application(s) or use(s) of the presented inventions.

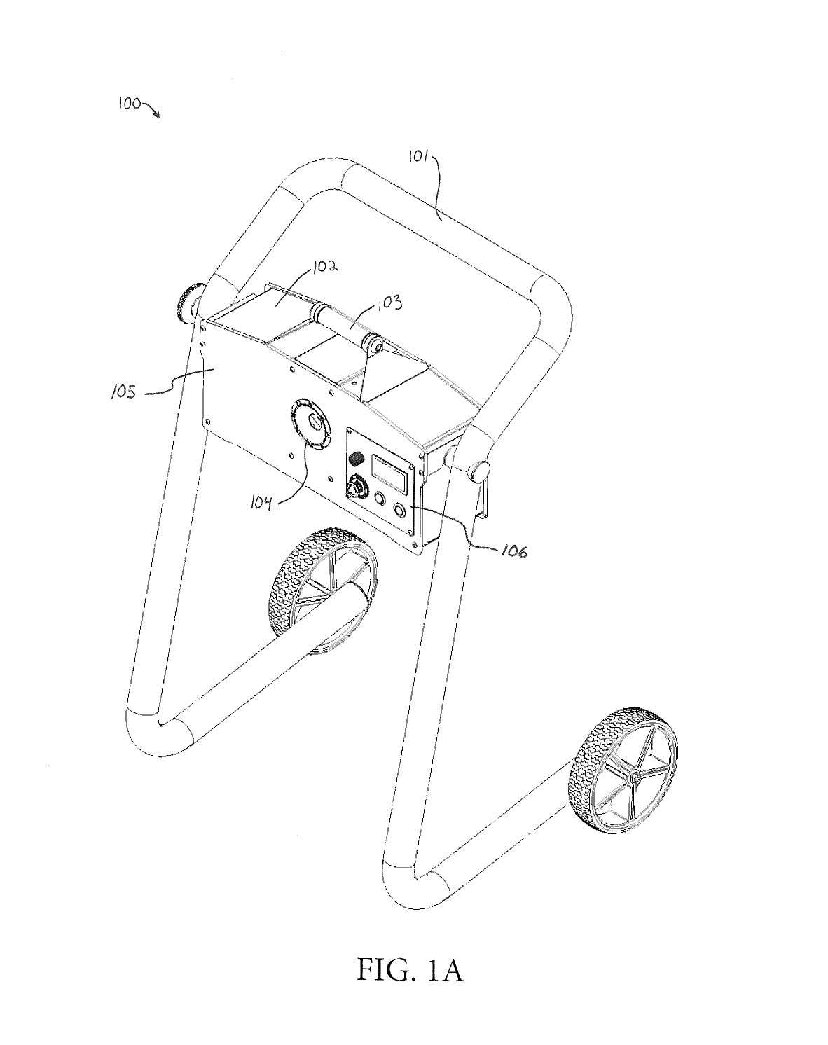

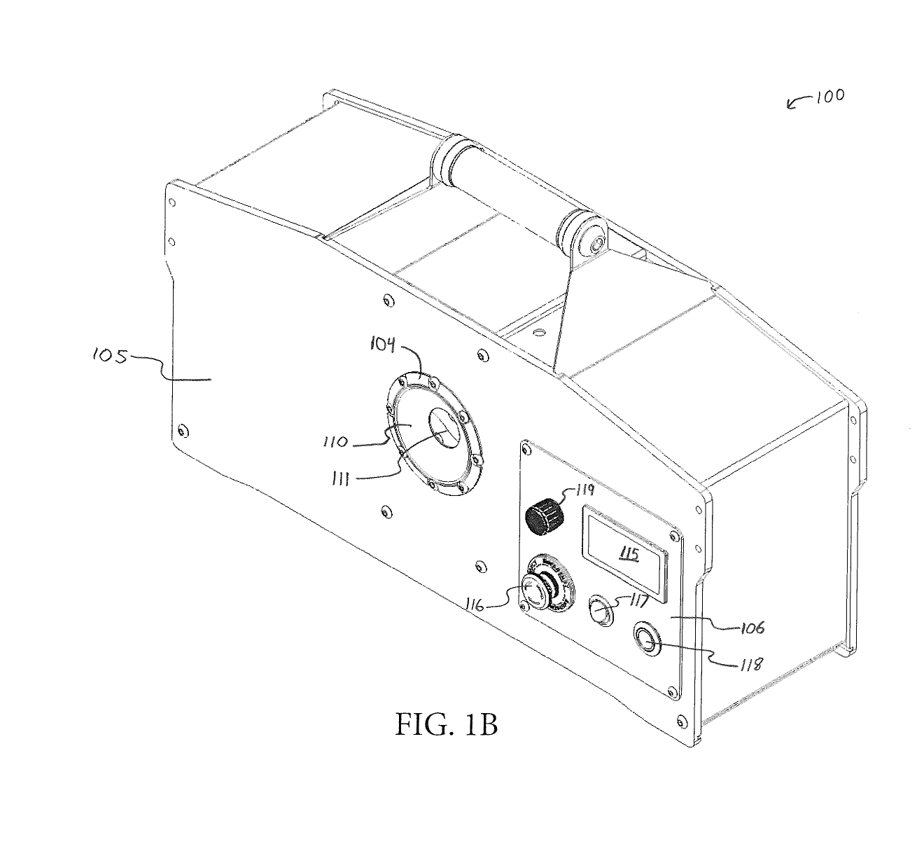

The presented device or machine is directed to removing plant material (e.g., buds, leaves, etc.) from the stem and branches of a plant. FIGS. 1A and 1B provide a front perspective view of a harvesting device 100 composed of two major assemblies: an iris mechanism 104 and a drive mechanism (not shown). The iris mechanism 104 and drive mechanism are disposed in a housing 102. The housing 102 may be constructed of any appropriate material(s) such as aluminum, steel, hard plastic, etc. and may be configured to shield users from debris and moving parts. The front plate 105 is preferably constructed from a hard metal such as steel to resist damage from repeated impact and scraping from branches, stems, etc. Notably, although illustrated as a rectangular housing having six walls, it should be appreciated that housing 102 may be of any appropriate size and shape configured to accommodate the iris mechanism and drive mechanism. For example, a back wall may be omitted to allow discarded plant stems to freely pass from the housing 102. Handle 103 and/or stand 101 may be optionally provided to assist in transporting and positioning the harvesting device 100.

The iris mechanism 104 may be the primary tool for the separation of plant material (e.g., buds and leaves) from the stem and branches of a plant, assisted by the pulling force generated by the drive mechanism. A user may manually feed a portion of a plant (e.g., the cut end of a stem of a harvested plant) through orifice 111 of the front plate 105 and through a cutting orifice of the iris mechanism 104. Inside housing 102, the drive mechanism may engage the plant and draw it through the iris mechanism 104. Blades of the iris mechanism 104 may scrape the sides of the stem and any protruding branches, thereby dislodging desirable portions of the plant (i.e., plant material) which may fall to the ground or into a collection bin. Optional guide plate 110, shown as a conical plate having an outer flange for mounting to the front plate 105 of the housing 102, may assist the user in guiding an end of a plant into the orifice 111 and may also assist in folding protrusions (e.g., branches) toward the stem of a plant to align them with the iris mechanism 104.

Harvesting device 100 may also include a control panel 106 having any number of operational control and feedback devices. In the illustrated embodiment, control panel 106 includes a display 115 (e.g., LCD), an emergency shutoff switch 116, a speed inversion switch 117, a power switch 118, and a speed selector knob 119. Display 115 may provide a user with visual feedback including, but not limited to, current operating speed, current blade or drive roller pressure, motor temperature, total hours of use, detected anomalies or maintenance issues, battery indicator, etc. Speed inversion switch 117 may be manipulated by a user to adjust the operating direction of the harvesting device 100. More specifically, the speed inversion switch 117 may adjust the operating direction of one or more drive motors (described in more detail below), as may be necessary to unjam a plant stuck in the drive mechanism. Power switch 118 may be any appropriate mechanism effective for powering on and off the harvesting device 100. Emergency shutoff switch 116 may be provided as a secondary means (in addition to the power switch 118) for quickly disengaging the drive motors of the drive mechanism. Speed selector knob 119 may be manipulated to adjust the rotational speed of one or more drive motors used to pull a plant stem through the harvesting device 100, thereby affecting the speed at which plants are fed through the harvesting device 100. It should be appreciated that the illustrated embodiment of control panel 106 is provided for example only. Each depicted switch, button, or knob may be optional and the arrangement of controls may be altered. For example, it may be desirable to locate emergency shutoff switch 116 on a rear panel of housing 102 or at another location remote from power switch 118 to provide a user with multiple options for shutting down the device in an emergency. Although not shown, in some embodiments a pressure selector knob may be provided to adjust one or more settings of a sensor (e.g., sensitivity) disposed within the harvesting device 100 used for monitoring the positioning a component. For example, as discussed below, the positioning of a drive roller of the drive mechanism may be adjustable to increase or decrease pressure exerted on the stem of a plant. This may be useful, for example, to ensure a sufficient grip on the stem to efficiently move the plant through the harvesting device 100 without exerting too much pressure which may crush the stem creating debris or causing the drive mechanism to jam. Additionally or alternatively, a pressure selection knob may adjust the pressure exerted by blades of the iris mechanism 104 on the stem of a plant. This may be desirable, for example, to ensure enough pressure to successfully dislodge plant material from the stem while not providing too much pressure causing the blades to trim off portions of the stem.

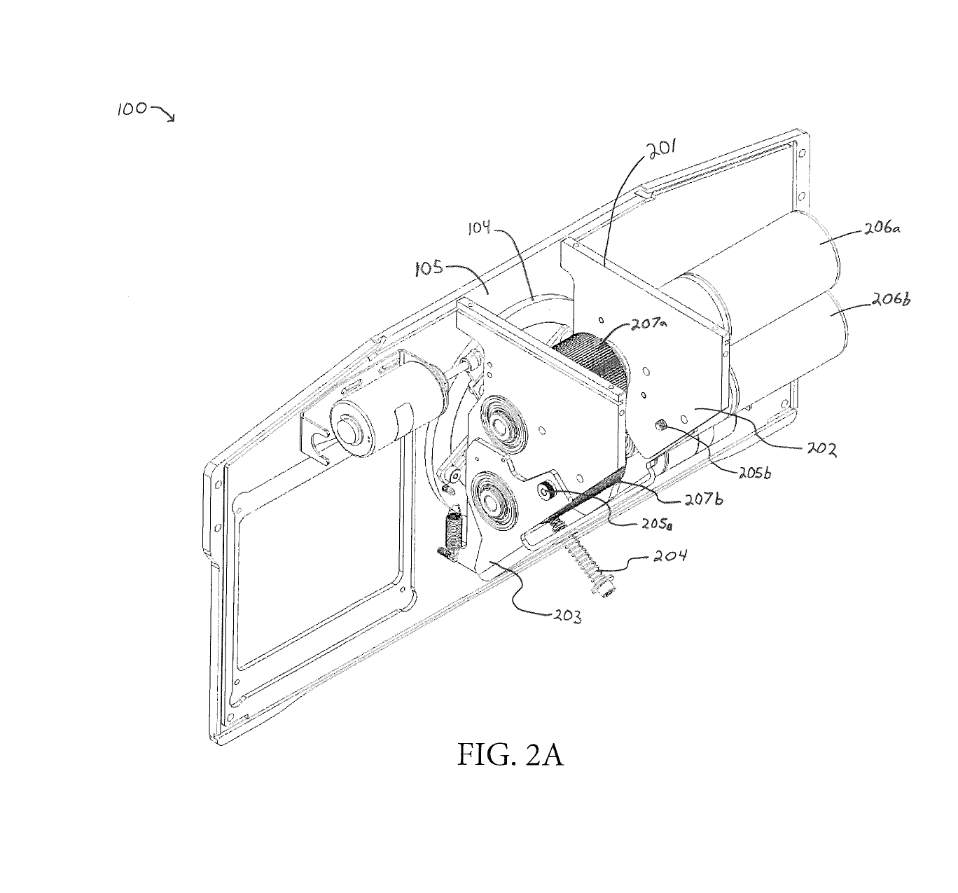

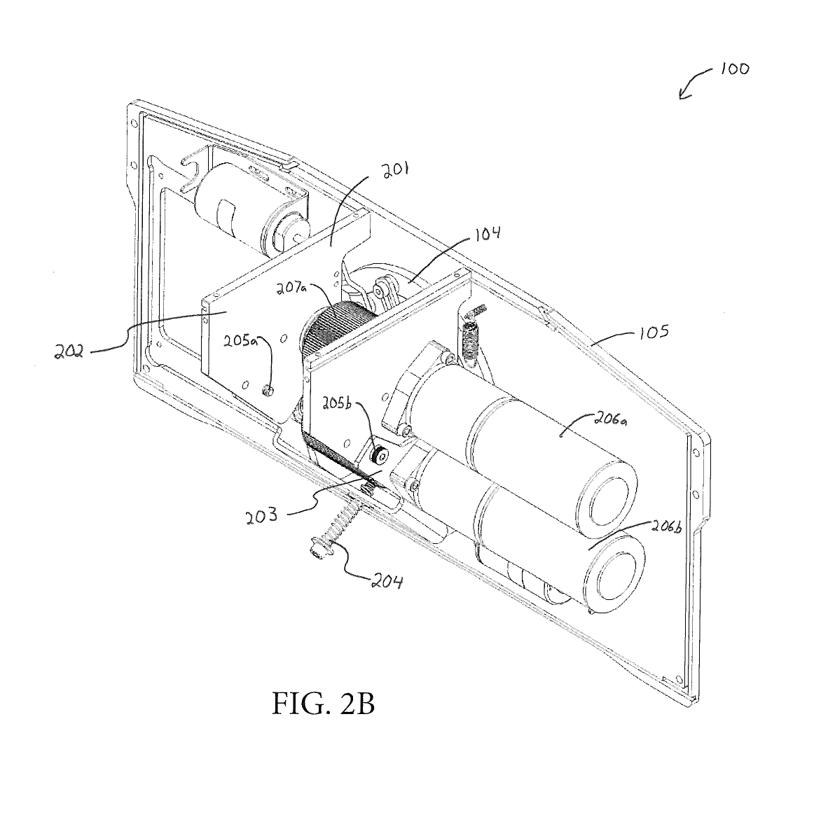

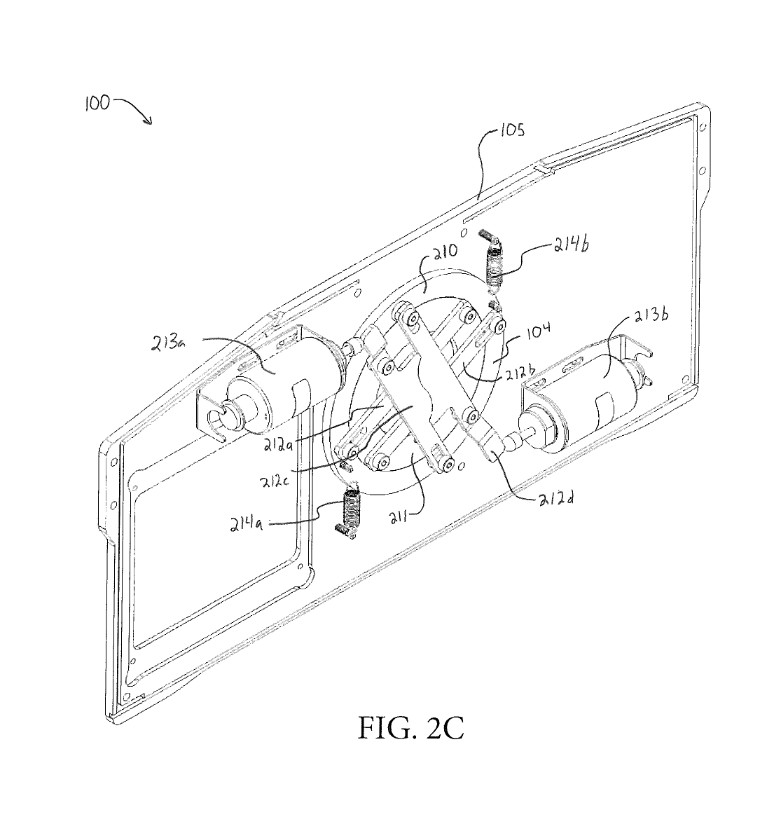

FIGS. 2A and 2B illustrate rear perspective views of a portion harvesting device 100 comprising drive mechanism 201 mounted over the iris mechanism 104 on the back side of front plate 105. Drive motors 206a, 206b rotate drive rollers 207a, 207b, respectively. Drive motor 206a and drive roller 207a are mounted to upper bracket 202, whereas drive motor 206b and drive roller 207b are mounted to lower bracket 203. In the illustrated embodiment, the upper bracket is fixedly attached to a front plate 105 of the device 100. Lower bracket 203 may be attached to upper bracket 202 and configured to pivot/rotate in relation thereto around an axis passing through pivot points 205a, 205b. Biasing member 204 may be configured to retain lower bracket 203 in a resting position. More specifically, the biasing member 204 may compress the rollers 207a, 207b toward one another. When a user inserts a portion of a plant through an orifice of the front plate 105 (e.g., orifice 111 of FIG. 1B) and through the cutting orifice of the iris mechanism 104, the plant may be engaged by drive mechanism 201. More specifically, the orifice 111 and a cutting orifice of the iris mechanism 104 may be disposed in relation to drive mechanism 201 such that upon insertion of a plant (e.g., plant stem) through the orifice 111 and the cutting orifice of the iris mechanism 104, the plant is engaged by and passes between drive rollers 207a, 207b.

Drive motor 206a may be configured to rotate drive roller 207a in a clockwise manner as viewed from the perspective of FIG. 2B while drive motor 206b may be configured to rotate drive roller 207b in a counterclockwise manner as viewed from the same perspective. That is, the rollers 207a and 207b rotate in a complementary manner to define an inlet nip. In this regard, upon engagement of the stem of a plant at the inlet nip between the rollers 207a, 207b, the complementary rotation of the drive rollers 207a, 207b pull the stem, thereby pulling the plant through orifice 111 and a cutting orifice of the iris mechanism 104. In some embodiments, only one drive motor (206a or 206b) may be provided such that the drive roller (207a or 207b) which is not attached to the drive motor is allowed to rotate freely as the stem passes between drive rollers 207a, 207b. As the plant/stem passes between the rollers 207a, 207b, the lower bracket 204 pivots relative to the upper bracket 202 allowing the rollers 207a, 207b to move away from one another (e.g., displace) to accommodate the thickness of the stem. The biasing member 204 resists this displacement urges the rollers 207a, 207b together. This compresses the plant/stem between the rollers 207a, 207b allowing the rollers to grip the plant such that the plant is drawn there between.

Drive rollers 207a, 207b may primarily be formed of any appropriate material. For example, plastic may be used to reduce weight, thereby reducing torque stress on drive motors 206a, 206b. Alternatively, metal such as steel may be used to increase the service life of drive rollers 207a, 207b. The contact surfaces of drive rollers 207a, 207b (e.g., the outer surface of the cylinder which engages a plant) may be configured for improved frictional engagement of plants. For example, as illustrated, drive rollers 207a, 207b are ribbed in a direction transverse to the direction of travel of an inserted plant. In this regard, the ribs may engage the plant firmly and reduce the probability of slippage. Additionally or alternatively, drive rollers 207a, 207b may comprise spikes, teeth, barbs, threads, and/or a grip coating such as rubber or adhesive, for example.

As noted, displacement or separation of drive rollers 207a, 207b may be mechanically controlled by biasing member 204, which counteracts the separation of drive rollers 207a, 207b as a plant stem is inserted between them. In the illustrated embodiment, upper drive motor 206a is attached to upper bracket 202 and lower drive motor 206b is attached to pivotally connected lower bracket 203 and biasing member 204 biases these brackets together. Biasing member 204 may be any appropriate device configured to bias lower bracket 203 toward upper bracket 202, or vice versa. As shown, biasing member 204 is a spring configured to compress when a plant is fed into drive mechanism 201 pushing drive rollers 207a, 207b apart. Wider portions of a plant may cause greater separation of drive rollers 207a, 207b and thereby greater compression of biasing member 204 and a greater return biasing force. Additionally or alternatively, a biasing member 204 may comprise a spring configured to elongate when a plant is fed into drive mechanism 201. For example, a spring may be mounted between front plate 105 and lower bracket 203 such that the spring pulls lower bracket 203 forward and/or upward toward front plate 105. In other embodiments, biasing member 204 may comprise a strut (e.g., pneumatic), a rubber band, torsional spring, leaf spring, etc. In other embodiments, drive motors 206a, 206b may not be configured to move with an upper bracket 202 and lower bracket 203. In such embodiments, separation of drive rollers 207a, 207b may be controlled automatically using linear actuators, servos, etc. controlled by sensors and a processing system.

As illustrated, upper bracket 202 and lower bracket 203 each comprise a left and right member generally defining a clevis, thereby providing a left and right mounting point for each of the drive rollers 207a, 207b. It should, however, be appreciated that such redundancy may not be necessary. For example, only one of the left or right member may be utilized for mounting of both drive motors and drive rollers. Alternatively, a drive motor may be mounted directly to front plate 105 or another portion of housing 102. In other words, although drive rollers 207a, 207b need to be positioned with respect to the cutting orifice, the specific means used to mount and position the drive rollers 207a, 207b in the illustrated embodiment may not be critical.

In the illustrated embodiment, drive rollers 207a, 207b are directly coupled to the shafts of drive motors 206a, 206b, respectively. However, it should be appreciated that alternative configurations are envisaged. For example, a drive motor may be affixed to a gear, the teeth of which are, in turn, engaged with teeth of a drive roller for indirect rotation of the drive roller by the drive motor.

FIG. 2C illustrates a rear perspective view of the portion harvesting device 100 shown in FIGS. 2A and 2B with the drive mechanism removed to provide an improved view of the iris mechanism 104 on the back side of front plate 105. Iris mechanism 104 may comprise a plurality of blades configured to form an adjustable diameter cutting orifice. As illustrated, iris mechanism 104 comprises four blades 212a-d although it is contemplated that two or more blades may be utilized. Additional blades may provide for a more refined circular cutting orifice. The iris mechanism 104 may further comprise a fixed ring and a rotating ring. As shown, the outer ring 210 is configured to rotate about the inner ring 211 which is fixed to the front plate 105. It should be appreciated that in some embodiments, a single ring may be provided with one end of each blade attached to the front plate 105 and the other end of each blade affixed to the rotating ring. Moreover, although shown and described as a ring, it should be appreciated that any appropriate shape may be used, for example, a “U” shape may effective for the functionality described herein.

Each of the plurality of blades 212a-d has a body including an elongated element which is attached near a first end to inner ring 211 and attached near a second end to outer ring 210. A portion of the body of the blade between the attachment regions forms a cutting edge that extends over the cutting orifice of the iris mechanism 104. Each cutting edge may be sharpened or beveled to aid in the removal of plant material. In the illustrated embodiment, one end of each blade 212a-d is attached to the inner ring 211 using a fastener 216 in a manner which allows rotation about a fixed point in relation to the inner ring 211 while the other end of each blade 212a-d is attached to the outer ring 210 via a slot which allows both rotation and longitudinal displacement of each blade 212a-d in relation to the point of attachment to the outer ring 210. Additionally, some or all of the blades 212a-d may include a tab member extending from one or both ends, configured for engagement by a linear actuator.

In the illustrated embodiment, there are two layers of blades. The forward layer comprises blades 212a, 212b and the rearward layer comprises 212c, 212d. The layering of blades 212a-d may be necessary to achieve a desired shape and size of cutting orifice. It should be appreciated that additional layers may be required as additional blades are added. Blades may be curved to allow rearward layers of blades to arch over forward layers of blades, or blades may be straight and spacers may be used at the points of attachment to the inner ring 211 and outer ring 210.

Blades 212a-d may be of any appropriate shape as needed to achieve a desired range of shapes and sizes for the cutting orifice. As illustrated, blades 212a-d have a widened cutting edge segment in a substantially central location along the length of each blade. Although the widened cutting edge is optional and may be of any shape, in the illustrated embodiment the cutting edge of each blade 212a-d comprises a curvilinear wave shape.

Blades 212a-d may be actuated by any actuating means. For example, an actuating means may comprise a handle to allow a user to manually rotate outer ring 210. As another example, outer ring 210 may comprise a series of teeth on a surface of the ring for engagement by corresponding teeth of an electric motor or servo to automatically rotate outer ring 210. In the illustrated embodiment, the actuating means includes linear actuators 213a, 213b. Linear actuator 213a is configured to engage blade 212c and linear actuator 213b is configured to engage blade 212d. In this regard, as the linear actuators 213a, 213b extend, the outer ring 210 of the iris mechanism 104 is rotated clockwise from the perspective of FIG. 2C. This rotation synchronizes the movement of blades 212a-d to create and adjust the size of a cutting orifice to adapt to a size of a plant during processing. Biasing springs 214a, 214b are configured to return outer ring 210 to its resting position when linear actuators 213a, 213b are withdrawn. As shown, biasing springs 214a, 214b rotate outer ring 210 in a direction which closes the cutting orifice in blades 212a-d but it should be appreciated that biasing springs 214a, 214b may be configured to rotate outer ring 210 in a direction which opens the cutting orifice. In such an embodiment, linear actuators 213a, 213b may be configured to close the cutting orifice.

Linear actuators 213a, 213b may be controlled by one or more components of a controller (e.g., control panel 106 of FIG. 1B). For example, a control knob may be provided such that manipulation of the control knob by a user causes the linear actuators 213a, 213b to extend or withdraw their shaft. As discussed further below, a sensor may also be provided for determining a desired cutting orifice configuration such that an output of the sensor may be used to control linear actuators 213a, 213b. It should be appreciated that although two linear actuators are shown, one or more linear actuators or other actuators (e.g. rotary) may be utilized.

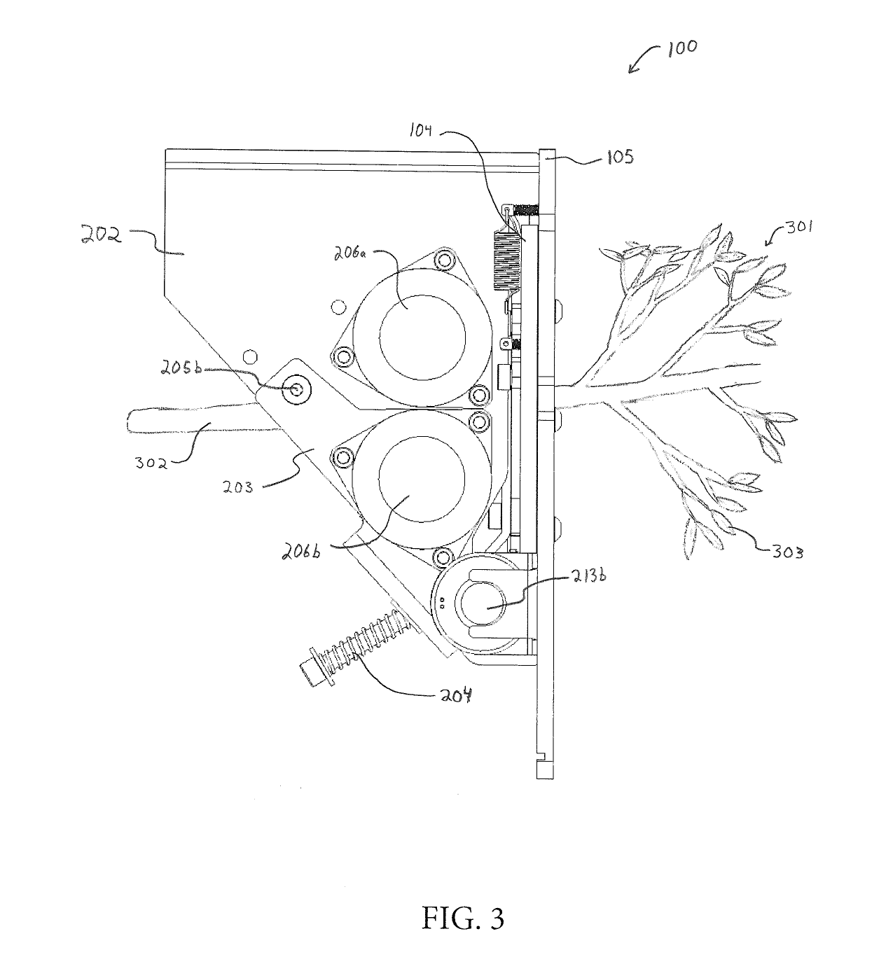

Turning to FIG. 3, harvesting device 100 is shown from a left-side view with housing 102 removed (except for front plate 105). When harvesting device 100 is in a resting state, drive motors 206a, 207b may be de-energized or may be operating at an idle speed. The cut end of a stem 302 of a plant 301 may be inserted through an orifice of the front plate 105. The stem 302 may pass through the cutting orifice of the iris mechanism 104 and contact one or both drive rollers (not shown). Engagement of the drive rollers with the stem 302 may be detected by one or more sensors, causing a processing system associated with the control panel to adjust the operating speed of the drive motors 206a, 206b and the configuration of the cutting orifice. Specifically, a sensor may detect the stem 302 and increase the speed of drive motors 206a, 206b to a predetermined or user-set operating speed. In this regard, the harvesting device 100 may have an idle speed (which may be below an operating speed or zero) when the machine is not in use and an operating speed (e.g., 100 RPM) when a plant is inserted. Such variance in speed may be advantageous for a variety of reasons. For example, operating at high speeds may expend more power such that it may be desirable to implement an idle speed to conserve power, thereby reducing energy costs and extending battery life (if batteries are used). Along these lines, it will be appreciated that the device may be battery operated, solar powered, or may utilize AC power (e.g., 110 volt). Moreover, high speed operation may reduce service life and increase maintenance costs such that implementation of idle speeds when the harvesting device 100 is not in active use may be preferable.

Furthermore, a sensor may determine the presence of the stem 302 based upon separation of the drive rollers. Upon determining the presence of the stem 302 the device recognizes that a plant is disposed through the orifice. Along these lines, a processing engine or controller associated with the control panel may interpret an output from the sensor and send control signals to the linear actuators to adjust a diameter of the cutting orifice accordingly. For example, upon identifying the presence of a stem between the rollers, the linear actuators may be actuated to close the cutting orifice about the plant. In one embodiment, the actuators may extend until a predetermined force is applied to the plant within the orifice. In another embodiment, it may be desirable to set a diameter of the cutting orifice to a predetermined size based on a size of the stem as determined form the output of the sensor. By way of example only, the blades of the orifice may be positioned to form an orifice that is 1/16″ greater than the measured diameter of the stem 302 to effectively strip plant material 303 from the stem 302 and/or branches. That is, a small offset value may be incorporated to account for a desired cutting orifice offset or an estimated change in diameter of the stem. For example, it may be desirable to set a diameter of the cutting orifice to a size that is slightly larger than the measured value of the stem to avoid cutting into and shearing off parts of the stem. Additionally, many stems may taper from a large diameter to a small diameter over the length of the plant. In this regard, the actual diameter of the stem as measured at the cutting orifice may be slightly smaller than the actual diameter of the stem as measured at the drive rollers 207a, 207b.

It will be appreciated that upon expulsion of the stem 302, biasing member 204 may return the drive rollers to their resting position which may be detected by a sensor, causing drive motors 206a, 206b to return to an idle speed and/or disengage the linear actuators 213a, 213b such that biasing springs 214a, 214b return the orifice to an open configuration. Both the operating speed and the idle speed may be set by a user. Moreover, the operating speed may be automatically adjusted as a function of the measured size of stem 302.

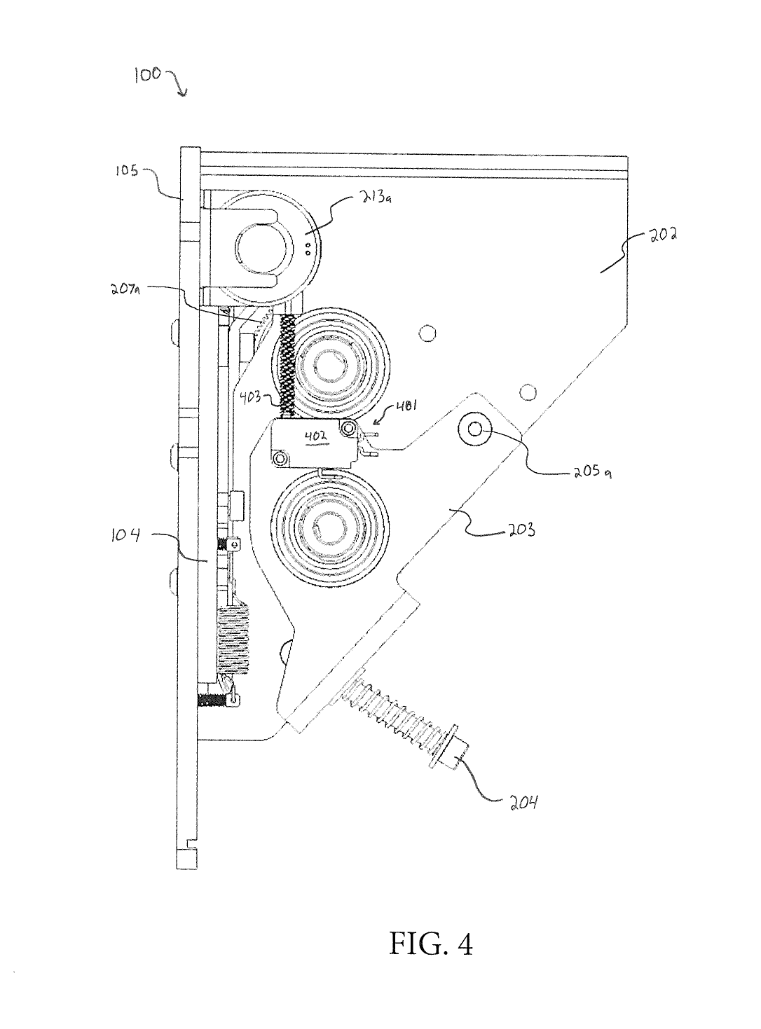

Turning to FIG. 4, harvesting device 100 is shown from a right-side view with housing 102 removed (except for front plate 105). Sensor 401 (described above in relation to FIG. 3) may be any appropriate device for detecting engagement of a stem with drive rollers 207a, 207b and/or a separation thereof (presumably caused by insertion of a stem). As shown, sensor 401 comprises a sensor body 402 mounted to the movable lower bracket 203 and sensor element (e.g., spring) 403 mounted to fixed upper bracket 202. As a stem is inserted into the harvesting device 100, it is received between drive rollers 207a, 207b causing lower bracket 203 to pivot about point 205a. The deflection resulting from the pivoting is detected by a change in force exerted by sensor element 403 on sensor body 402. Accordingly, an output signal may be transmitted from sensor 402 to a control panel or other processing device. In response to the output, the control panel may transmit a control signal to the actuating means of the iris mechanism 104 (e.g., linear actuator 213a) to adjust a size of the cutting orifice to correspond to the separation of the drive rollers 207a, 207b.

Although sensor 401 is shown as a mechanical sensor using a sensor spring 403, it should be appreciated that any appropriate sensing device may be used. For example, an electromagnetic sensor, an optical sensor, a rotary encoder, or a linear displacement device may be used.

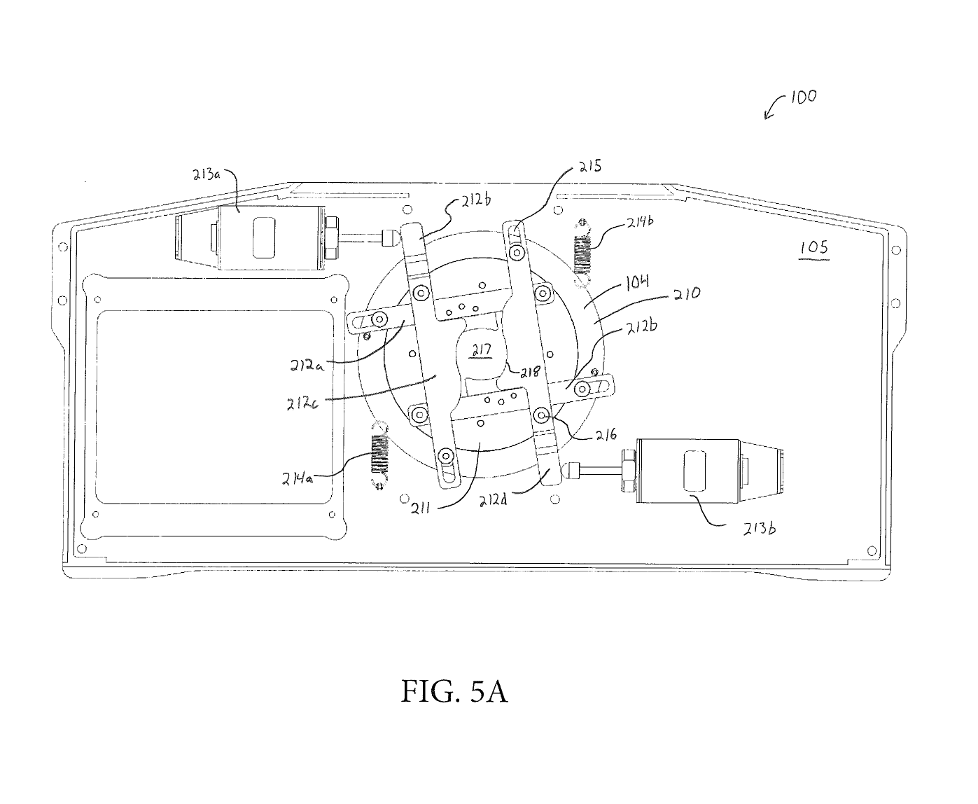

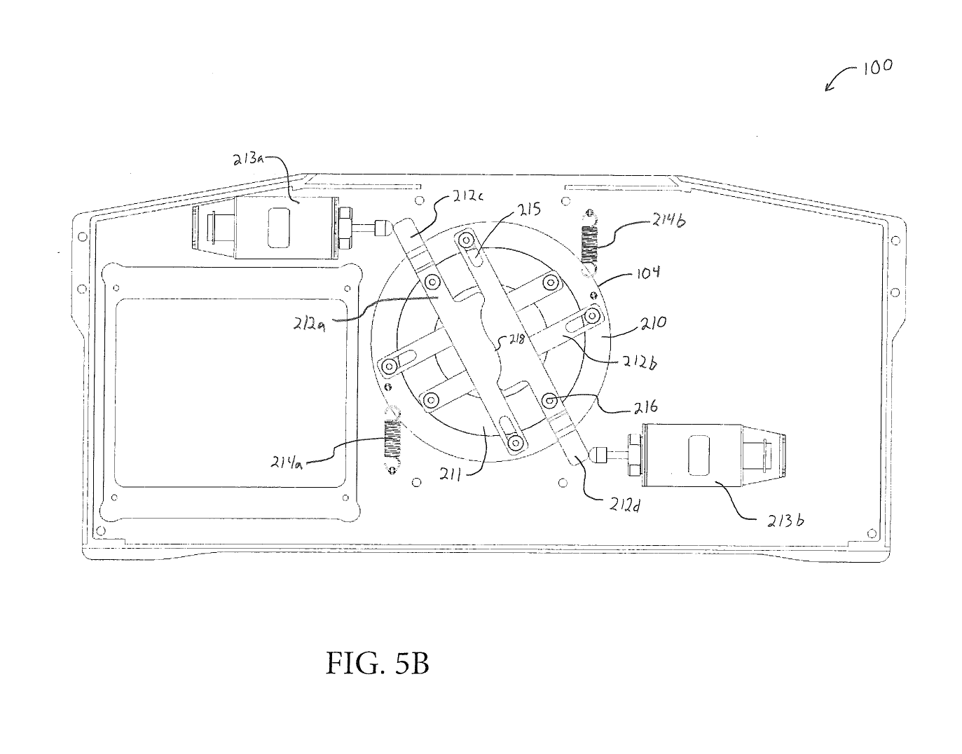

FIG. 5A illustrates the iris mechanism 204 in an open configuration. In this configuration, the cutting edges of the blades 212a-d (e.g., cutting edge 218 of blade 212d) are separated from one another. In this regard, cutting orifice 217 is formed between blades 212a-d and the shafts of linear actuators 213a, 213b are extended, thereby overpowering the biasing springs 214a, 214b to open the iris mechanism 104. FIG. 5B shows the iris mechanism 204 in the closed configuration. In this configuration, the cutting edges of the blades (e.g., cutting edge 218 of blade 212d) are in contact with at least one other blade (or are disposed in close relation thereto). In this illustrated embodiment, the shape of the cutting edges of the blades result in continuous contact across the length of the cutting surfaces, thereby eliminating any orifice. In this configuration, the shafts of linear actuators 213a, 213b are withdrawn, thereby allowing biasing springs 214a, 214b to hold the iris mechanism 104 in the closed configuration. It should appreciated that a continuum of configurations are possible to accommodate various stem sizes between the open configuration of FIG. 5A and the closed configuration of 5B.

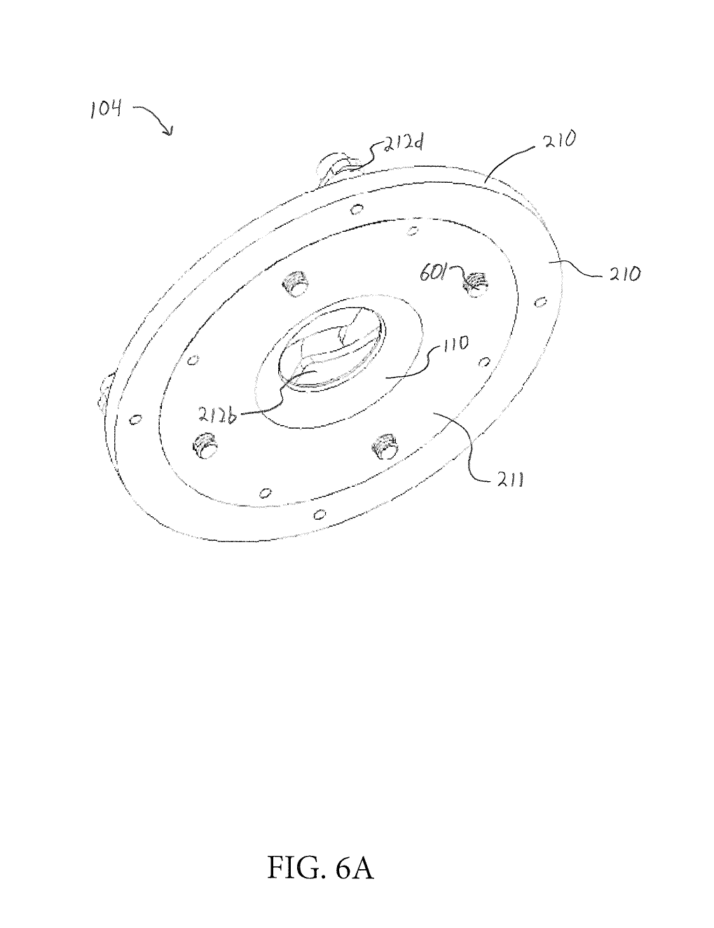

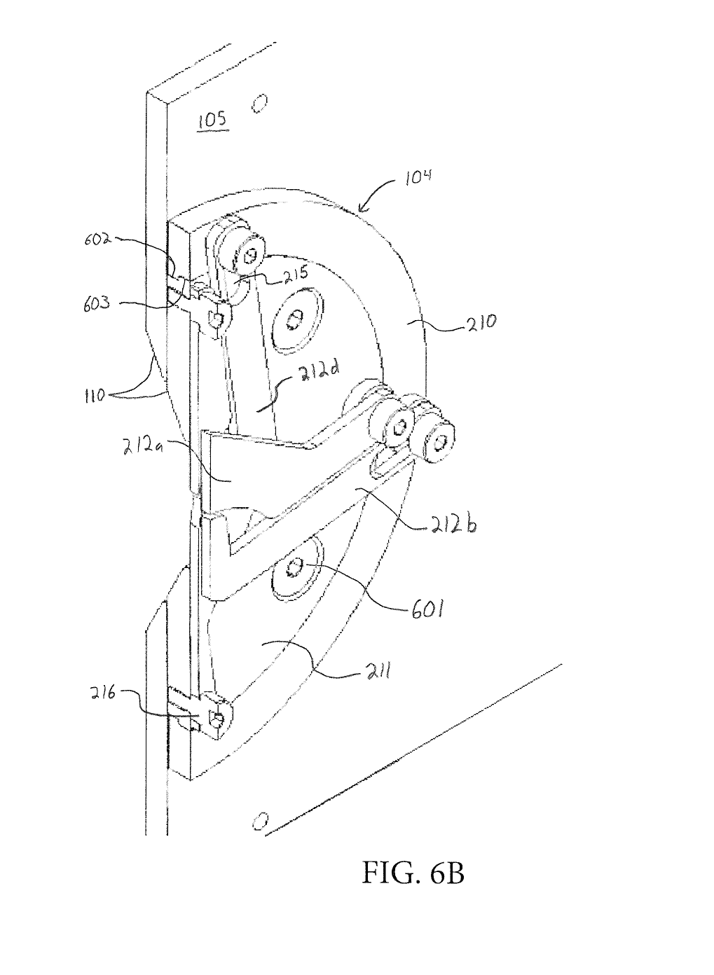

FIG. 6A shows a front perspective view of the iris mechanism 104 as removed from the front plate of the device 100. Although any suitable means may be utilized (adhesives, welding, integrated construction, etc.), in the illustrated embodiment bolts (e.g., bolt 601) may be used to secure the iris mechanism 104 to the front plate 105 of the housing 102 of the harvesting device. Specifically, inner ring 211 may be fixedly attached to the front plate 105 (or another portion of housing 102). Outer ring 210 may be slidably engaged with inner ring 211 (discussed below) and blades 212a-d may be affixed to inner ring 211 and outer ring 210 such that all illustrated portions of the iris mechanism 104 are secured to the harvesting device 100 using the bolts disposed through inner ring 211.

FIG. 6B provides a cross section through a rear perspective view of iris mechanism 104 as secured to front plate 105. Any appropriate type of fastener (e.g., fastener 216) may be used to secure the blades 212a-d to the inner ring 211 and outer ring 210. The outer ring 210 may be secured to the inner ring 211 for rotation with respect thereto using any appropriate means. In the illustrated embodiment, lip 602 of the outer ring is sandwiched between the front plate 105 and lip 603 of the inner ring. In this regard, the outer ring 210 is securely affixed to the iris mechanism 104 while remaining able to rotate. Other embodiments may include, for example, a tongue and groove, ball bearings, etc.

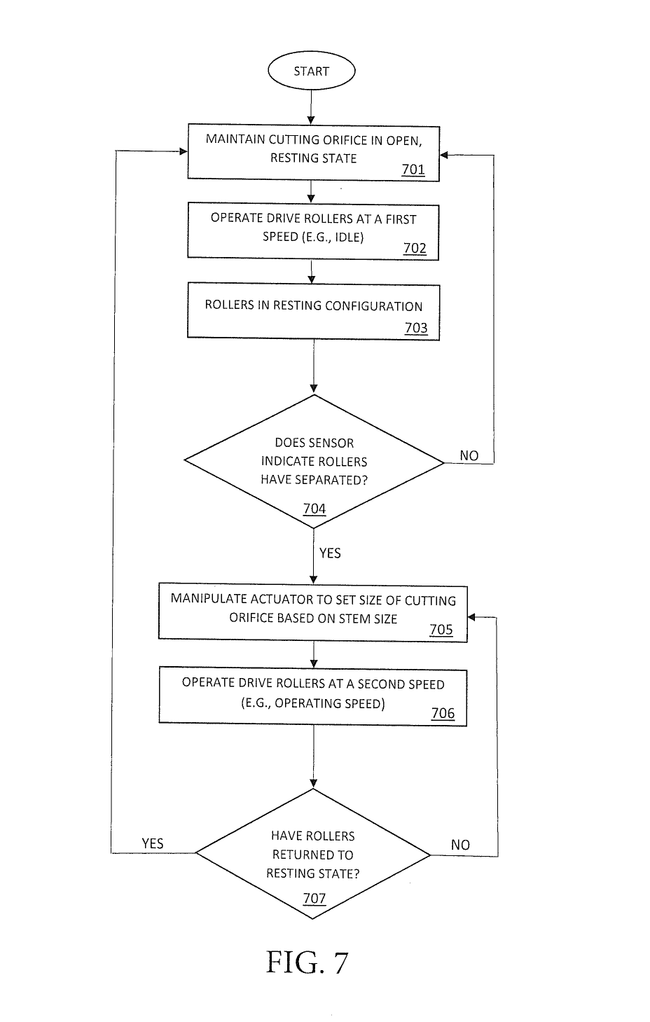

Turning to FIG. 7, a method for operating a harvesting device is shown. Initially, a controller (e.g., control panel, processing engine, etc.) of the harvesting device may maintain the device in a resting configuration. In no particular order, the resting configuration may comprise maintaining the cutting orifice in an open and/or resting position 701, operating the drive roller(s) at a first speed 702, and disposing the drive rollers in a resting configuration 703. This configuration may leave the cutting orifice open so that a stem of a plant may be inserted, the drive rollers operating slowly such that they will engage an inserted plant. A sensor may provide an output at regularly determined intervals (e.g., each 0.05s) or in real-time to the controller. The controller may monitor fluctuation in the output from the sensor to determine if the drive rollers have separated as may be indicative of insertion of a plant 704. If the drive rollers have not separated but rather remain in their resting positions, the controller may maintain the harvesting device in the resting configuration 701, 702, 703. If, however, the controller detects that the drive rollers have separated, it may transition the harvesting device into an operational configuration. In this configuration, the actuating means may be manipulated to set the size of the cutting orifice in accordance with a detected presence of the stem 705. Additionally, the drive rollers may be operated at a faster speed 706. While in the operational configuration, the controller may continue monitoring the output signal(s) from the sensor 707. If it is determined that the drive rollers are still separated, indicating that a plant is still engaged by the harvesting device, the controller will maintain the harvesting device in the operational configuration 705, 706. If, however, the controller determines that the drive rollers have returned to their resting position, indicating that the plant has been ejected from the harvesting device, the controller will transition the harvesting device back into the resting configuration 701, 702, 703.

It should be appreciated that the controller may have time thresholds associated with various operations. For example, after determining that there is no longer a plant engaged by the harvesting device, the controller may continue to operate the device in the operational configuration for a predetermined period of time (e.g., 30 seconds, 1 minute, etc.) before returning to the resting configuration. This may allow, for example, a user to collect and insert an additional plant without the harvesting device needing to change states. During this time, the controller may return the iris mechanism to the open or resting configuration while maintaining the drive rollers at operational speed. Furthermore, after a predetermined period of time during which the harvesting device remains in the resting configuration without detecting the insertion of a plant, the controller may turn the harvesting device off or transition it into a non-operative “sleep” configuration.

It should also be appreciated that some of the steps illustrated in the method of FIG. 7 may be optional. For example, a resting speed may not be required. Rather, the drive rollers may be configured to operate at one speed at all times (as may be set by a user using the control panel).

The foregoing description has been presented for purposes of illustration and description. Furthermore, the description is not intended to limit the inventions and/or aspects of the inventions to the forms disclosed herein. Consequently, variations and modifications commensurate with the above teachings, and skill and knowledge of the relevant art, are within the scope of the presented inventions. The embodiments described hereinabove are further intended to explain best modes known of practicing the inventions and to enable others skilled in the art to utilize the inventions in such, or other embodiments and with various modifications required by the particular application(s) or use(s) of the presented inventions. It is intended that the appended claims be construed to include alternative embodiments to the extent permitted by the prior art.

What is claimed is:

1. A harvesting device for separating plant material from a stem and branches of a plant, comprising:
an iris mechanism comprising:
an outer ring;
an inner ring concentrically disposed within the outer ring; and
a plurality of blades, wherein each blade of the plurality of blades is pivotally attached to the outer ring and pivotally attached to the inner ring, and wherein the plurality of blades are configured to form a cutting orifice such that rotation of the outer ring changes a dimension of the cutting orifice; and
a drive mechanism comprising:
a first electric motor;
a first drive roller rotationally powered by the first electric motor; and
a second drive roller, wherein the first and second drive rollers are configured to receive and engage a stem of a plant to pull the plant through the cutting orifice.

2. The harvesting device of claim 1, further comprising:
a second drive motor, wherein the second drive roller is rotationally powered by the second drive motor, and wherein a direction of rotation of the first drive motor is opposite of a direction of rotation of the second drive motor.

3. The harvesting device of claim 1, further comprising:
an upper bracket, wherein the first drive roller is mounted to the upper bracket;
a lower bracket, wherein the second drive roller is mounted the lower bracket and the lower bracket is pivotally affixed to the upper bracket, and wherein insertion of a stem of a plant causes the lower bracket to pivot in a first direction with respect to the upper bracket, thereby increasing a dimension of a gap between the first and second drive rollers; and
a biasing member configured to pivot the lower bracket in a second direction with respect to the upper bracket, wherein the second direction is opposite the first direction.

4. The harvesting device of claim 3, further comprising:
an actuating means for rotating the outer ring, the actuating means comprising:
a first actuator configured to rotate the outer ring with respect to the inner ring when the first actuator is actuated; and
a first biasing member configured to return the outer ring to a resting position when the first actuator is inactive.

5. The harvesting device of claim 4, wherein a shaft of the first actuator is configured to engage a portion of one of the plurality of blades such that a force exerted on the one of the plurality of blades by the shaft of the first actuator causes the outer ring to rotate.

6. The harvesting device of claim 5, wherein each of the plurality of blades comprises a slot through which an attachment element is disposed to pivotally attach each of the plurality of blades to the outer ring, and wherein each of the plurality of blades is configured to slide in relation to a respective attachment element in conjunction with rotation of the outer ring.

7. The harvesting device of claim 4, further comprising:
a sensor configured to determine a magnitude of the gap between the first and second drive rollers.

8. The harvesting device of claim 7, further comprising:
a control panel comprising a processing engine, wherein the control panel is in operative communication with the sensor, the first electric motor, and the first actuator, and wherein the control panel is configured to receive an output signal from the sensor corresponding to the magnitude of the gap between the first and second drive rollers and transmit an iris control signal to the first actuator in response to the output signal.

9. The harvesting device of claim 8, wherein the output signal indicates an increase in magnitude of the gap and the control panel is operable to transmit a motor control signal to the first drive motor in response to receipt of the output signal, wherein the motor control signal is configured to increase an operational speed of the first drive motor.

10. The harvesting device of claim 4, further comprising:
a second actuator configured to rotate the outer ring with respect to the inner ring when the second actuator is actuated.

11. The harvesting device of claim 1, further comprising:
a housing, wherein the housing comprises:
a front plate; and
a plurality of walls extending normally from the front plate;
wherein housing forms an enclosure around at least a portion of the iris mechanism and the drive mechanism.

12. The harvesting device of claim 11, further comprising:
a back plate disposed at an end of the plurality of walls opposite the front plate;
wherein the front plate, the plurality of walls, and the back plate are each constructed from a metal.

13. The harvesting device of claim 12, wherein the metal comprises at least one of steel, aluminum, and iron.

14. The harvesting device of claim 11, further comprising:
a stand comprising:
a body;
a plurality of wheels; and
a handle;
wherein the housing is mounted to the body of the stand.

15. A method for removing plant material from a plant, comprising:
receiving a portion of a plant in drive mechanism of a harvesting device;
rotating a first drive roller and a second drive roller of the drive mechanism to engage the portion of the plant and pull the plant through the harvesting device;
manipulating an actuating means to rotate an outer ring of an iris mechanism in a first direction about a concentrically disposed inner ring, and wherein rotation of the outer ring causes repositioning of a plurality of blades affixed to the outer ring and inner ring which form a cutting orifice;
stripping, with the cutting orifice, plant material from a stem of the plant as the drive mechanism pulls the plant through the harvesting device.

16. The method of claim 15, wherein the actuating means comprises a linear actuator, and wherein the method further comprises:
detecting, using a sensor, a magnitude of a gap between the first roller and the second roller; and
manipulating, in response to the detecting, a shaft of the linear actuator to reposition the plurality of blades to size the cutting orifice based upon the detected magnitude of the gap.

17. The method of claim 16, wherein engagement of the portion of the plant causes a lower bracket to which the second drive roller is attached to pivot in relation to an upper bracket to which the first drive roller is attached.

18. The method of claim 16, further comprising:
operating the first and second drive rollers at a first rotational speed;
operating the first and second drive rollers at a second rotational speed based upon detecting an increase in the magnitude of the gap, wherein the second rotational speed is faster than the first rotational speed.

19. The method of claim 18, further comprising:
detecting a decrease in the magnitude of the gap; and
operating, in response to the detecting the decrease in the magnitude of the gap, the first and second drive rollers at the first rotational speed.

20. The method of claim 19, further comprising:
manipulating, in response to the detecting the decrease in the magnitude of the gap, the shaft of the linear actuator to allow a biasing spring to rotate the outer ring a second direction, wherein the second direction is opposite of the first direction.
